(19) United States
(12) Patent Application Publication
(10) Pub. No.: US 2017/0241700 A1
(43) Pub. Date: Aug. 24, 2017

(54) Water Reservoir Assembly and a Refrigerator Appliance

(71) Applicant: General Electric Company, Schenectady, NY (US)

(72) Inventor: Alan Joseph Mitchell, Louisville, KY (US)

(21) Appl. No.: 15/051,713

(22) Filed: Feb. 24, 2016

(51) Int. Cl. F25D 23/12; G01F 23/00; F25D 29/00; F25D 11/02; F25D 17/06

(52) U.S. Cl. CPC F25D 23/126; F25D 11/02; F25D 17/065; F25D 29/00; G01F 23/00; F25D 2323/122

(57) ABSTRACT

A water reservoir includes a casing that defines a water chamber. A cover is disposed around a portion of the casing. The cover defines an air chamber. An air handler is operable to urge of a flow of air through the air chamber of the cover. A related refrigerator appliance is also provided.

### FIELD OF THE INVENTION

The present subject matter relates generally to water reservoirs, such as water reservoirs for refrigerator appliances.

### BACKGROUND OF THE INVENTION

Refrigerator appliances frequently include a dispenser for directing chilled water and/or ice into a container thereby facilitating access to the chilled water and/or ice. To provide chilled water, certain refrigerator appliances include a tank disposed within a fresh food chamber of the refrigerator appliances. Water within the tank is chilled to a temperature of the fresh food chamber and may be directed out of the tank via the dispenser. Fresh food chambers are generally cooled to around forty degrees Fahrenheit. Thus, chilled water from the tank may be around forty degrees Fahrenheit.

Chilled water at around forty degrees Fahrenheit is suitable for many purposes. For example, certain consumers prefer drinking chilled water at around forty degrees Fahrenheit. However, chilled water at around forty degrees Fahrenheit is too warm for other purposes. For example, generating carbonated water can require chilled water at between thirty-two degrees Fahrenheit and thirty-five degrees Fahrenheit. Utilizing water from a tank within a fresh food chamber of a refrigerator appliance to provide water between thirty-two degrees Fahrenheit and thirty-five degrees Fahrenheit is difficult.

Accordingly, a water reservoir with features for generating chilled water within a refrigerator appliance would be useful. In particular, a water reservoir with features for generating chilled water between thirty-two degrees Fahrenheit and thirty-five degrees Fahrenheit within a refrigerator appliance would be useful.

### BRIEF DESCRIPTION OF THE INVENTION

The present subject matter provides a water reservoir. The water reservoir includes a casing that defines a water chamber. A cover is disposed around a portion of the casing. The cover defines an air chamber. An air handler is operable to urge of a flow of air through the air chamber of the cover. A related refrigerator appliance is also provided. Additional aspects and advantages of the invention will be set forth in part in the following description, or may be apparent from the description, or may be learned through practice of the invention.

In a first exemplary embodiment, a water reservoir is provided. The water reservoir includes a casing that defines a water chamber. An inlet conduit is mounted to the casing. An inlet valve is coupled to the inlet conduit and is configured for regulating a flow of water into the water chamber of the casing through the inlet conduit. An outlet conduit is mounted to the casing. An outlet valve is coupled to the outlet conduit and is configured for regulating a flow of water out of the water chamber of the casing through the outlet conduit. A cover is disposed around a portion of the casing. The cover defines an air chamber. An air handler is operable to urge of a flow of air through the air chamber of the cover.

In a second exemplary embodiment, a refrigerator appliance is provided. The refrigerator appliance includes a housing that defines a chilled chamber. A water reservoir is disposed within the housing. The water reservoir includes a casing that defines a water chamber. An inlet conduit is mounted to the casing. An inlet valve is coupled to the inlet conduit and is configured for regulating a flow of water into the water chamber of the casing through the inlet conduit. An outlet conduit is mounted to the casing. An outlet valve is coupled to the outlet conduit and is configured for regulating a flow of water out of the water chamber of the casing through the outlet conduit. A cover is disposed around a portion of the casing. The cover defines an air chamber. An air handler is operable to urge of a flow of air through the air chamber of the cover.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1 with refrigerator doors of the refrigerator appliance shown in an open position to reveal a fresh food chamber of the refrigerator appliance.

FIGS. 3 and 4 provide schematic views of a water reservoir according to an exemplary embodiment of the present subject matter during a filling operation of the exemplary water reservoir.

FIGS. 5 and 6 provide schematic views of the exemplary water reservoir of FIG. 3 during a dispensing operation of the exemplary water reservoir.

FIG. 7 provides a section view of a casing of the exemplary water reservoir of FIG. 3.

FIG. 8 provides a schematic view of the exemplary water reservoir of FIG. 3 equipped with baffles.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

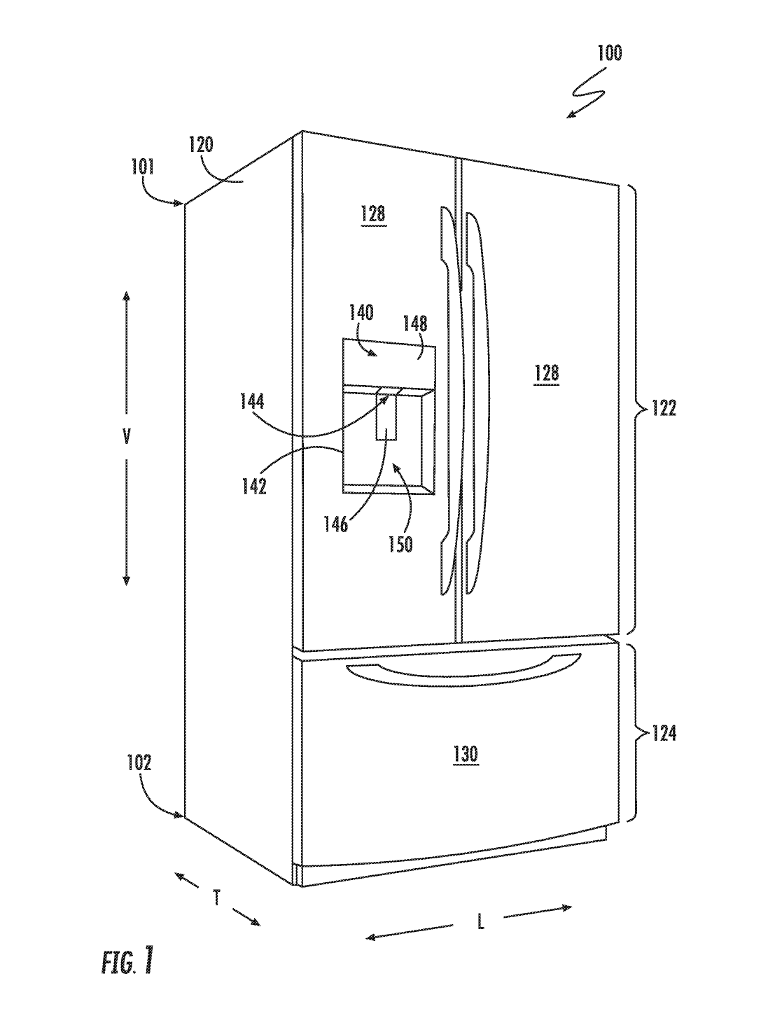

FIG. 1 provides a perspective view of a refrigerator appliance 100 according to an exemplary embodiment of the present subject matter. Refrigerator appliance 100 includes a cabinet or housing 120 that extends between a top 101 and a bottom 102 along a vertical direction V. Housing also extends along a lateral direction L and a transverse direction T, each of the vertical direction V, lateral direction L, and transverse direction T being mutually perpendicular to one another. Housing 120 defines chilled chambers for receipt of food items for storage. In particular, housing 120 defines a fresh food chamber 122 positioned at or adjacent top 101 of housing 120 and a freezer chamber 124 arranged at or adjacent bottom 102 of housing 120. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1.

Refrigerator appliance 100 also includes a dispensing assembly 140 for dispensing liquid water and/or ice. Dispensing assembly 140 includes a dispenser 142 positioned on or mounted to an exterior portion of refrigerator appliance 100, e.g., on one of refrigerator doors 128. Dispenser 142 includes a discharging outlet 144 for accessing ice and liquid water. An actuating mechanism 146, shown as a paddle, is mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button rather than the paddle. A control panel 148 is provided for controlling the mode of operation. For example, control panel 148 includes a plurality of user inputs (not labeled), such as a water dispensing button and an ice-dispensing button, for selecting a desired mode of operation such as crushed or non-crushed ice.

Discharging outlet 144 and actuating mechanism 146 are an external part of dispenser 142 and are mounted in a dispenser recess 150. Dispenser recess 150 is positioned at a predetermined elevation convenient for a user to access ice or water and enabling the user to access ice without the need to bend-over and without the need to open refrigerator doors 128. In the exemplary embodiment, dispenser recess 150 is positioned at a level that approximates the chest level of a user. As described in more detail below, the dispensing assembly 140 may receive ice from an icemaker disposed in a sub-compartment of the fresh food chamber 122.

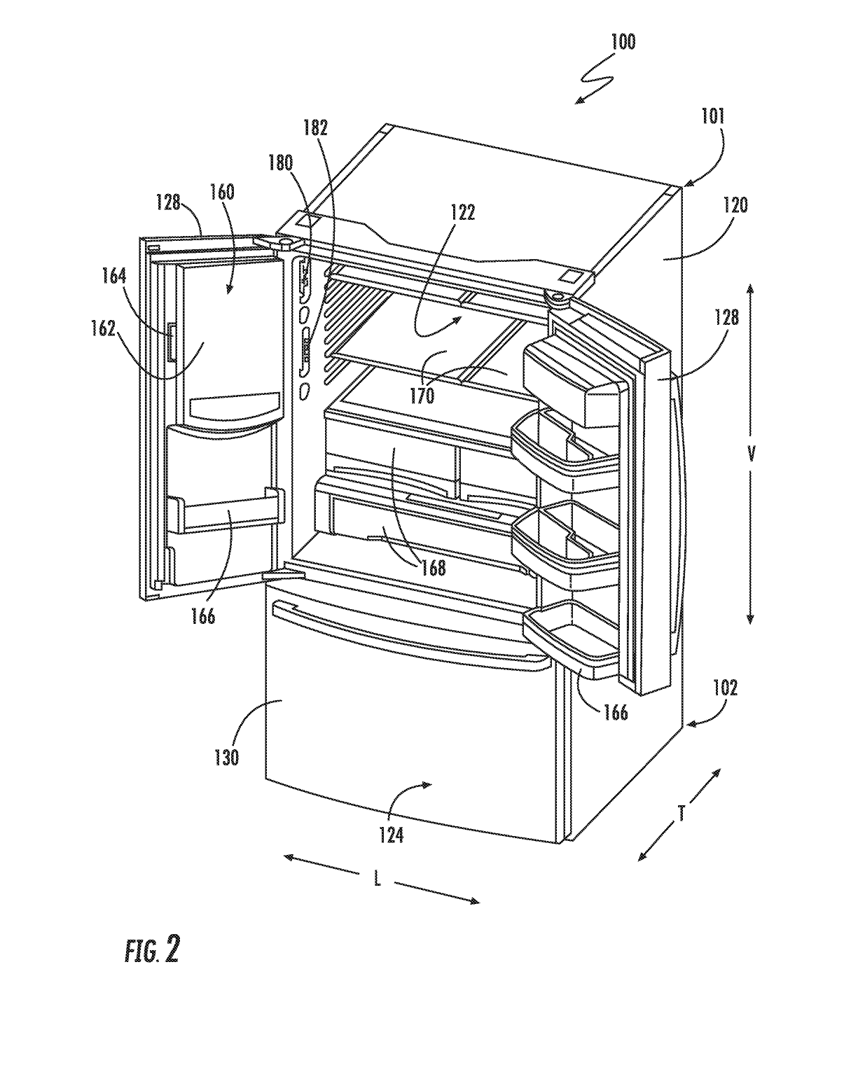

FIG. 2 provides a perspective view of a door of refrigerator appliance 100 shown with refrigerator doors 128 in the open position. Refrigerator appliance 100 includes a sub-compartment, e.g., icebox compartment 160 defined on refrigerator door 128. Icebox compartment 160 extends into fresh food chamber 122 when refrigerator door 128 is in the closed position. As discussed in greater detail below, a water reservoir 200, icemaker and/or an ice storage bin (not shown) may be positioned or disposed within icebox compartment 160. Thus, ice is supplied to dispenser recess 150 (FIG. 1) from the icemaker and ice storage bin in icebox compartment 160 on a back side of refrigerator door 128.

An access door 162 is hinged to refrigerator door 128 or to icebox compartment 160. Access door 162 permits selective access to icebox compartment 160. Any manner of suitable latch 164 is configured with icebox compartment 160 to maintain access door 162 in a closed position. As an example, latch 164 may be actuated by a consumer in order to open access door 162 for providing access into icebox compartment 160. Access door 162 can also assist with insulating icebox compartment 160, e.g., by thermally isolating or insulating icebox compartment 160 from fresh food chamber 122.

According to the illustrated embodiment, various storage components are mounted within fresh food chamber 122 to facilitate storage of food items therein as will be understood by those skilled in the art. In particular, the storage components include bins 166, drawers 168, and shelves 170 that are mounted within fresh food chamber 122. Bins 166, drawers 168, and shelves 170 are configured for receipt of food items (e.g., beverages and/or solid food items) and may assist with organizing such food items. As an example, drawers 168 can receive fresh food items (e.g., vegetables, fruits, and/or cheeses) and increase the useful life of such fresh food items.

As will be discussed below, refrigerator appliance 100 may include a water reservoir 200 for chilling water within or at icebox compartment 160. In order to cool components of refrigerator appliance 100 within icebox compartment 160 to a suitable temperature, chilled air supply duct 180 and chilled air return duct 182 may be disposed on a side portion of the housing 120 of the refrigerator appliance 100. In this manner, the supply duct 180 and return duct 182 may recirculate chilled air from freezer chamber 124 through icebox compartment 160.

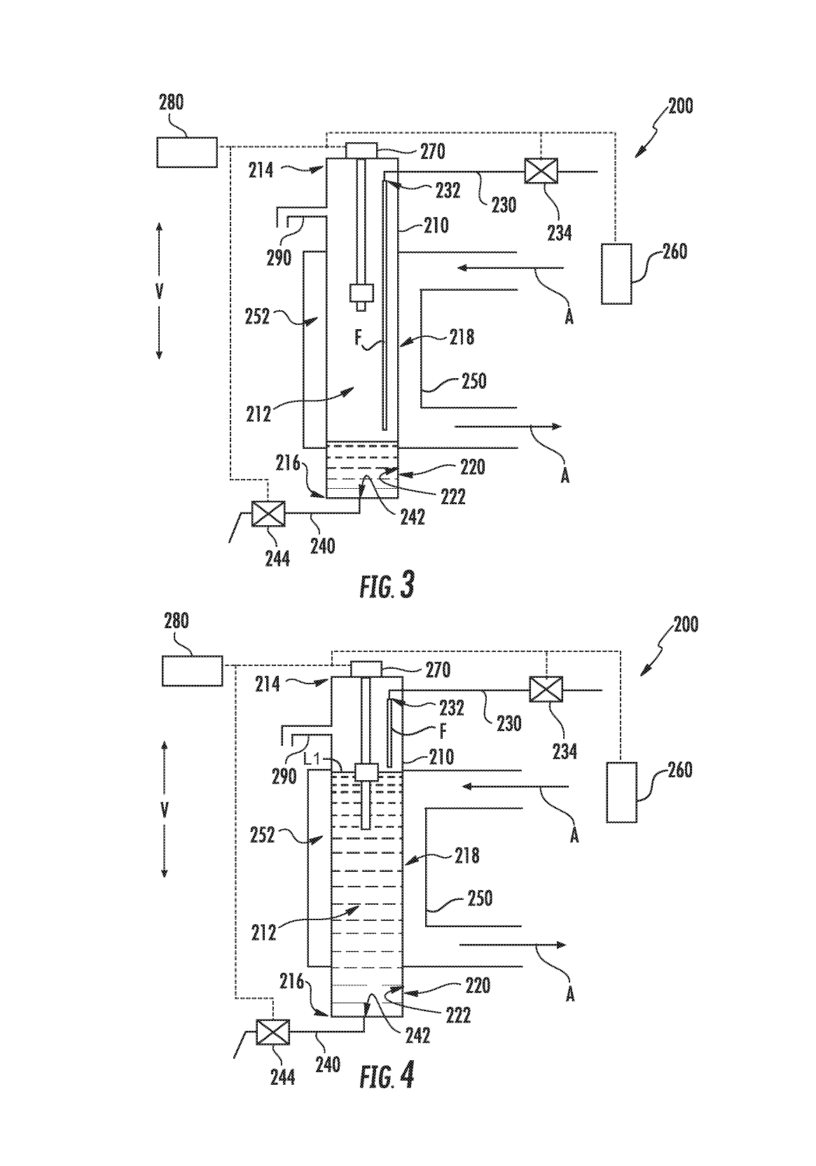

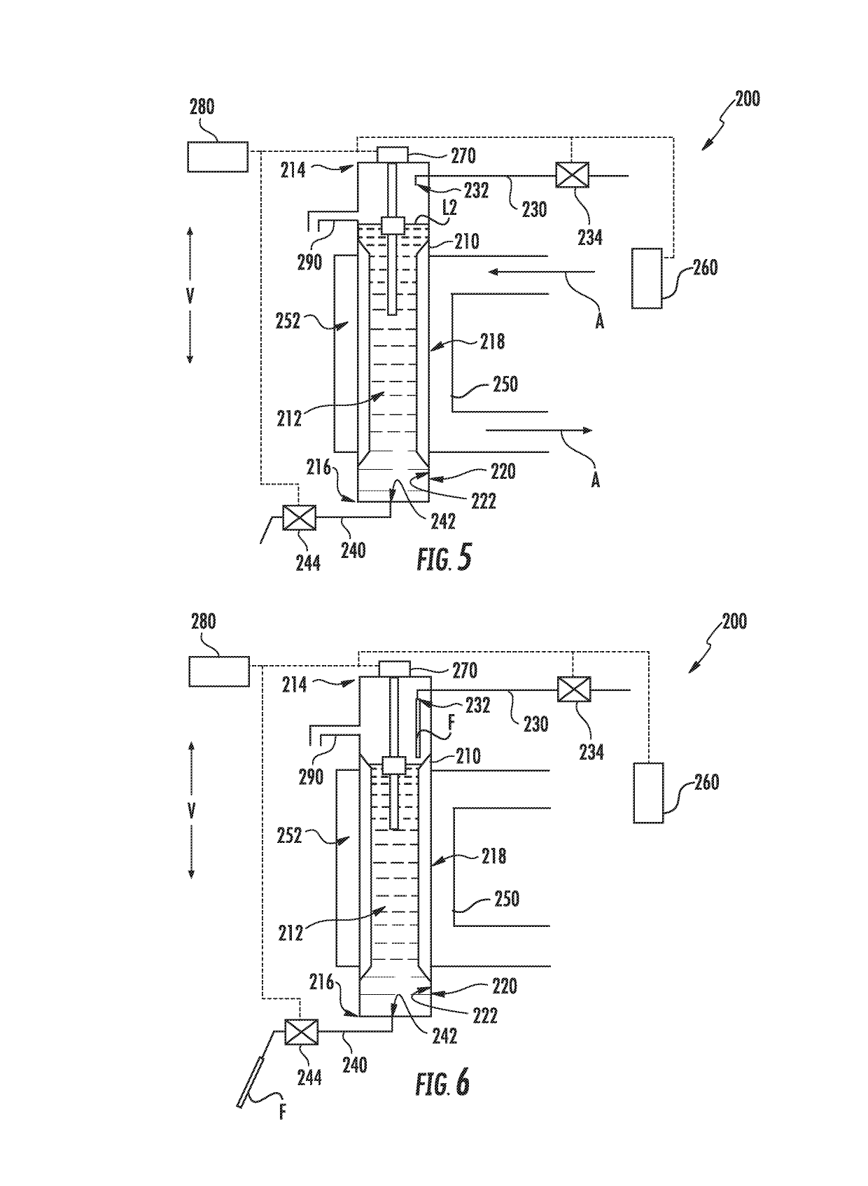

FIGS. 3-6 provide schematic views of a water reservoir 200 according to an exemplary embodiment of the present subject matter. Water reservoir 200 is shown in various stages of a filling operation of water reservoir 200 in FIGS. 3 and 4, and water reservoir 200 is shown in various stages of a dispensing operation of water reservoir 200 in FIGS. 5 and 6. Water reservoir 200 may be used in or with any suitable refrigerator appliance. For example, water reservoir 200 may be used in or with refrigerator appliance 100, e.g., to provide chilled water to dispenser 142 or other components of refrigerator appliance 100. Thus, water reservoir 200 is discussed in greater detail below in the context of refrigerator appliance 100. As also discussed in greater detail below, water reservoir 200 includes features for chilling liquid water, e.g., to a temperature between thirty-two degrees Fahrenheit and thirty-five degrees Fahrenheit.

As may be seen in FIG. 3, water reservoir 200 includes a casing 210 that defines a water chamber 212. Water chamber 212 is configured to receive a flow of liquid water, cool the liquid water within water chamber 212 and direct a flow of chilled liquid water out of water chamber 212. Thus, water chamber 212 of casing 210 is configured for containing water therein, e.g., while the water is cooling. Casing 210, e.g., water chamber 212 of casing 210, extends between a top portion 214 and a bottom portion 216 along the vertical direction V. A middle portion 218 of casing 210, e.g., water chamber 212 of casing 210, is disposed between top and bottom portions 214, 216 of casing 210 along the vertical direction V.

To direct water into water chamber 212 of casing 210, water reservoir 200 includes an inlet conduit 230 that is mounted to casing 210. Inlet conduit 230 may be mounted to casing 210 at top portion 214 of casing 210. An exit 232 of inlet conduit 230 may be contiguous or disposed in water chamber 212 of casing 210. Water within inlet conduit 230 may enter water chamber 212 of casing 210 at exit 232 of inlet conduit 230. Thus, water may flow into water chamber 212 of casing 210 at or adjacent top portion 214 of casing 210.

To direct water out of water chamber 212 of casing 210, water reservoir 200 includes an outlet conduit 240 that is mounted to casing 210. Outlet conduit 240 may be mounted to casing 210 at bottom portion 216 of casing 210. An entrance 242 of outlet conduit 240 may be contiguous or disposed in water chamber 212 of casing 210. Water within outlet conduit 240 may exit water chamber 212 of casing 210 at entrance 242 of outlet conduit 240. Thus, water may flow from water chamber 212 of casing 210 at or adjacent bottom portion 216 of casing 210.

An inlet valve 234 is coupled to inlet conduit 230. Inlet valve 234 is configured for regulating a flow of water F into water chamber 212 of casing 210 through or via inlet conduit 230. As an example, inlet valve 234 may be selectively adjustable or actuatable between an open configuration and a closed configuration. In the open configuration, inlet valve 234 permits the flow of water F (e.g., from a pressurized water source, such as a municipal water system or well) to flow through inlet conduit 230 into water chamber 212 of casing 210. Conversely, in the closed configuration, inlet valve 234 blocks or prevents the flow of water F through inlet conduit 230 into water chamber 212 of casing 210. Inlet valve 234 may be any suitable valve, such as an electrically actuatable solenoid valve.

An outlet valve 244 is coupled to outlet conduit 240. Outlet valve 244 is configured for regulating the flow of water F out of water chamber 212 of casing 210 through or via outlet conduit 240. As an example, outlet valve 244 may be selectively adjustable or actuatable between an open configuration and a closed configuration. In the open configuration, outlet valve 244 permits the flow of water F to flow through outlet conduit 240 from water chamber 212 of casing 210. Conversely, in the closed configuration, outlet valve 244 blocks or prevents the flow of water F out of water chamber 212 of casing 210 through outlet conduit 230. Outlet valve 244 may be any suitable valve, such as an electrically actuatable solenoid valve. In alternative exemplary embodiments, outlet valve 244 may include a pump that selectively draws the flow of water F out of water chamber 212 of casing 210 through or via outlet conduit 240.

Water reservoir 200 also includes a cover 250 and an air handler 260. Cover 250 is disposed around a portion of casing 210. For example, cover 250 may extend around casing 210 at middle portion 218 of casing 210, e.g., below top portion 214 of casing 210 and above bottom portion 216 of casing 210 along the vertical direction V. Cover 250 defines an air chamber 252. Air chamber 252 of cover 250 may be contiguous with or exposed to an outer surface 220 of casing 210. Air chamber 252 is configured to receive a flow of chilled air A, direct the flow of chilled air A around water chamber 212 of casing 210 and/or direct the flow of chilled air A out of air chamber 252. Thus, air chamber 252 of cover 250 is configured for containing chilled air therein, e.g., in order to cool water within casing 210 with the chilled air.

Air handler 260 is operable to urge the flow of chilled air A through air chamber 252 of cover 250. During operation of air handler 260, the flow of chilled air A may cool casing 210 such that ice forms on an inner surface 222 of casing 210 at water chamber 212 of casing 210. Air handler 260 may be a fan or any other suitable mechanism for driving air through air chamber 252. Air handler 260 may be positioned at any suitable location. For example, air handler 260 may be mounted to cover 250, air supply duct 180 of housing 120 or chilled air return duct 182 of housing 120 (FIG. 2). In certain exemplary embodiments, air handler 260 may be positioned for drawing chilled air from freezer chamber 124 through air chamber 252 of cover 250 during operation of air handler 260.

Air chamber 252 of cover 250 may be positioned at or adjacent middle portion 218 of casing 210, e.g., below top portion 214 of casing 210 and below bottom portion 216 of casing 210 along the vertical direction V. Conversely, cover 250 may not extend around casing 210 at or adjacent top and bottom portions 214, 216 of casing 210. Thus, air chamber 252 of cover 250 may be positioned below exit 232 of inlet conduit 230 and above entrance 242 of outlet conduit 240 along the vertical direction V. In such a manner, only water within water chamber 212 of casing 210 at or adjacent middle portion 218 of casing 210 may be cooled to freezing with air in air chamber 252 of cover 250. In particular, top and bottom portions 214, 216 of casing 210 may be exposed to ambient air about water reservoir 200 rather than chilled air within air chamber 252 of cover 250, e.g., such that ice forms at middle portion 218 of casing 210 and/or does not form at or adjacent top and bottom portions 214, 216 of casing 210 during operation of water reservoir 200.

Water reservoir 200 may also include a relief conduit 290. Relief conduit 290 is mounted to or formed on casing 210, e.g., at top portion 214 of casing 210 above air chamber 252 of cover 250. Relief conduit 290 is contiguous with ambient air about casing 210 and/or water chamber 212 of casing 210. Thus, water chamber 212 of casing 210 may be vented to ambient air about water reservoir 200 via relief conduit 290.

As may be seen in FIG. 3, water reservoir 200 also includes a water level sensor 270. Water level sensor 270 is operable to detect a level of water within water chamber 212 of casing 210. Based upon readings from water level sensor 270, a controller 280 of water reservoir 200 may open and close inlet valve 234 and/or outlet valve 244, as discussed in greater detail below. Water level sensor 270 may be any suitable water level sensor, such as a float-type water level sensor, a hydrostatic-type water level sensor, a load cell type water level sensor, capacitance-type water level sensors, etc. For example, water level sensor 270 may include a magnetic float and magnetic sensors, such as magnetic reed switches or Hall Effect sensors, actuatable in response to the magnetic float in order to detect a location of the magnetic float along the vertical direction V that in turn corresponds to the level of water within water chamber 212 of casing 210.

Operation of water reservoir 200 can be regulated by controller 280 that is operatively coupled to various components of water reservoir 200, such as inlet valve 234, outlet valve 244, air handler 260 and/or water level sensor 270. Controller 280 may operate various components of water reservoir 200, e.g., in response to signals from water level sensor 270. Controller 280 may include a memory and one or more microprocessors, CPUs or the like, such as general or special purpose microprocessors operable to execute programming instructions or micro-control code associated with operation of water reservoir 200. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 280 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 280 may be positioned in a variety of locations throughout refrigerator appliance 100. In the illustrated embodiment, controller 280 is located within control panel 148 (FIG. 1). In other embodiments, the controller 280 may be positioned at any suitable location within refrigerator appliance 100, such as for example within a fresh food chamber, a freezer door, etc. Input/output (“I/O”) signals may be routed between controller 280 and various operational components of water reservoir 200. For example, control panel 148 may be in communication with controller 280 via one or more signal lines or shared communication busses.

Operation of water reservoir 200 is discussed in greater detail below in the context of FIGS. 3-6. To fill water reservoir 200, controller 280 may open inlet valve 234 such that the flow of water F enters water chamber 212 of casing 210 via inlet conduit 230, as shown in FIGS. 3 and 4. Controller 280 may keep inlet valve 234 open until water level sensor 270 detects that the level of water within water chamber 212 of casing 210 is at or above a first threshold level L1 (FIG. 4) and then close inlet valve 234 and terminate the flow of water F into water chamber 212 of casing 210. With water chamber 212 of casing 210 filled with water, controller 280 activates air handler 260 to urge the flow of chilled air A into air chamber 252 of cover 250. When air handler 260 is activated, the flow of chilled air A cools casing 210 such that ice forms on inner surface 222 of casing 210, as shown in FIG. 5. As ice forms within water chamber 212, the level of water within waster chamber 212 rises. Controller 280 may keep air handler 260 active until water level sensor 270 detects that the level of water within water chamber 212 of casing 210 is at or above a second threshold level L2 (FIG. 5), e.g., above or greater than the first threshold level L1, and then deactivate air handler 260 and terminate the flow of chilled air A into air chamber 252 of cover 250. To dispense chilled water, controller 280 may open outlet valve 244 such that the flow of water F exits water chamber 212 of casing 210 via outlet conduit 240, as shown in FIG. 6. Controller 280 may also open inlet valve 234 such that the flow of water F enters water chamber 212 of casing 210 via inlet conduit 230 and replaces the dispensed water from outlet conduit 240.

As shown in FIG. 6, ice may be formed on casing 210 within water chamber 212 of casing 212 during dispensing of water from casing 210. The ice may cool liquid water passing through water chamber 212 at middle portion 218, e.g., to a temperature between thirty-two degrees Fahrenheit and thirty-five degrees Fahrenheit. Thus, water exiting water reservoir 200 via outlet conduit 240 may be chilled to a temperature between thirty-two degrees Fahrenheit and thirty-five degrees Fahrenheit. Such chilled water may be suitable for generating carbonated water. Thus, water reservoir 200 may include a carbonation injector (not shown) coupled to outlet conduit 240 in certain exemplary embodiments. The carbonation injector may inject gas into the flow of chilled water within outlet conduit 240 such that carbonated water is dispensed from outlet conduit 240 or provided to a carbonated beverage mixing module.

Water reservoir 200 may be disposed within an atmosphere having a temperature greater than the freezing temperature of water. For example, water reservoir 200 may be disposed such that water reservoir 200 is within fresh food chamber 122 or is exposed to air from fresh food chamber 122. Air handler 260 may actively cool middle portion 218 of casing 210 to form ice at middle portion 218 of casing 210, while top and bottom portions 214, 216 of casing 210 are exposed to air from fresh food chamber 122 and ice does not form at top and bottom portions 214, 216 of casing 210. Thus, mixed phase water (e.g., liquid and solid water) are disposed within water chamber 212 of casing 210 during operation of water reservoir 200 and a large volume of cold water may be dispensed from water reservoir 200.

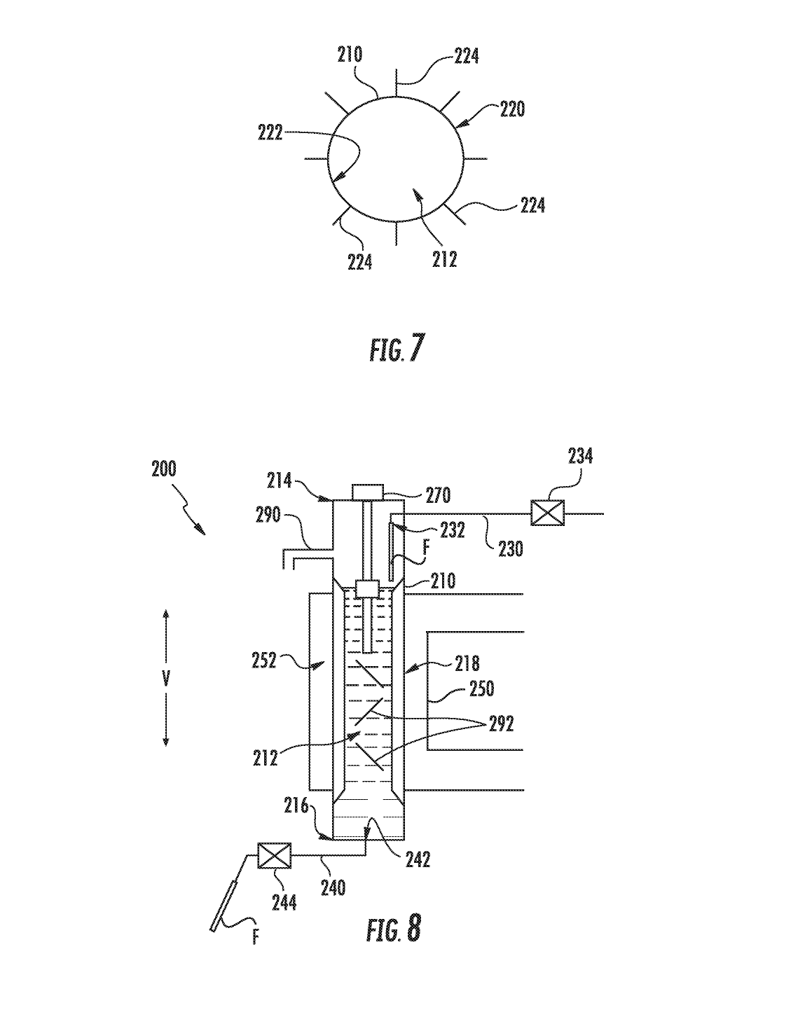

FIG. 7 provides a section view of casing 210. As shown in FIG. 7, casing 210 may include a plurality of fins, splines or projections 224. Projections 224 extend from outer surface 220 of casing 210 into air chamber 252 of cover 250. Projections 224 may facilitate heat transfer between the flow of chilled air A within air chamber 252 and casing 210. Thus, casing 210 and/or projections 224 may be formed of or with a thermally conductive material, such as a metal. As an example, casing 210 and/or projections 224 may be integrally formed of cast aluminum.

FIG. 8 provides a schematic view of water reservoir 200 equipped with baffles 292. Baffles 292 are disposed within water chamber 212 of casing 210. Baffle 292 are positioned and oriented for deflecting water flow through water chamber 212 of casing 210 towards inner surface 222 of casing 210. Thus, baffles 292 direct water flow through water chamber 212 at middle portion 218 of casing 210 towards inner surface 222 of casing 210, e.g., and thereby facilitate ice formation on inner surface 222 of casing 210 and/or cooling of water flowing through middle portion 218 of casing 210 with ice on inner surface 222 of casing 210.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water reservoir, comprising:
a casing defining a water chamber;
an inlet conduit mounted to the casing;
an inlet valve coupled to the inlet conduit and configured for regulating a flow of water into the water chamber of the casing through the inlet conduit;
an outlet conduit mounted to the casing;
an outlet valve coupled to the outlet conduit and configured for regulating a flow of water out of the water chamber of the casing through the outlet conduit;
a cover disposed around a portion of the casing, the cover defining an air chamber; and
an air handler operable to urge of a flow of air through the air chamber of the cover.

2. The water reservoir of claim 1, wherein an exit of the inlet conduit is contiguous with the water chamber of the casing, the exit of the inlet conduit positioned above the air chamber of the cover.

3. The water reservoir of claim 2, wherein an entrance of the outlet conduit is contiguous with the water chamber of the casing, the entrance of the outlet conduit positioned below the air chamber of the cover.

4. The water reservoir of claim 1, wherein the air chamber of the casing extends around the casing at a middle portion of the casing.

5. The water reservoir of claim 1, wherein the air chamber of the casing is contiguous with an outer surface of the casing.

6. The water reservoir of claim 5, wherein the casing comprises a plurality of projections, the projections of the plurality of projections extending from the outer surface of the casing into the air chamber of the cover.

7. The water reservoir of claim 1, further comprising a water level sensor operable to detect a level of water within the water chamber of the casing, the water level sensor being in communication with the inlet valve such that the inlet valve closes and terminates the flow of water into the water chamber of the casing through the inlet conduit when the water level sensor detects that the level of water within the water chamber of the casing is above a first threshold level.

8. The water reservoir of claim 7, wherein the water level sensor is also in communication with the air handler such that the air handler deactivates and terminates the flow of air through the air chamber of the cover when the water level sensor detects that the level of water within the water chamber of the casing is above a second threshold level, the second threshold level being higher than the first threshold level.

9. The water reservoir of claim 1, further comprising a baffle disposed within the water chamber of the casing, the baffle positioned and oriented for deflecting water flow through the water chamber of the casing towards an inner surface of the casing.

10. The water reservoir of claim 1, further comprising a relief conduit mounted to the casing above the air chamber of the cover, the relief conduit contiguous with ambient air about the casing.

11. A refrigerator appliance, comprising:
a housing defining a chilled chamber;
a water reservoir disposed within the housing, the water reservoir comprising
a casing defining a water chamber;
an inlet conduit mounted to the casing;
an inlet valve coupled to the inlet conduit and configured for regulating
a flow of water into the water chamber of the casing through the inlet conduit;
an outlet conduit mounted to the casing;
an outlet valve coupled to the outlet conduit and configured for regulating a flow of water out of the water chamber of the casing through the outlet conduit;
a cover disposed around a portion of the casing, the cover defining an air chamber; and
an air handler operable to urge of a flow of air through the air chamber of the cover.

12. The refrigerator appliance of claim 11, wherein an exit of the inlet conduit is contiguous with the water chamber of the casing, the exit of the inlet conduit positioned above the air chamber of the cover.

13. The refrigerator appliance of claim 12, wherein an entrance of the outlet conduit is contiguous with the water chamber of the casing, the entrance of the outlet conduit positioned below the air chamber of the cover.

14. The refrigerator appliance of claim 11, wherein the air chamber of the casing extends around the casing at a middle portion of the casing.

15. The refrigerator appliance of claim 11, wherein the air chamber of the casing is contiguous with an outer surface of the casing.

16. The refrigerator appliance of claim 15, wherein the casing comprises a plurality of projections, the projections of the plurality of projections extending from the outer surface of the casing into the air chamber of the cover.

17. The refrigerator appliance of claim 11, wherein the water reservoir further comprises a water level sensor operable to detect a level of water within the water chamber of the casing, the water level sensor being in communication with the inlet valve such that the inlet valve closes and terminates the flow of water into the water chamber of the casing through the inlet conduit when the water level sensor detects that the level of water within the water chamber of the casing is above a first threshold level.

18. The refrigerator appliance of claim 17, wherein the water level sensor is also in communication with the air handler such that the air handler deactivates and terminates the flow of air through the air chamber of the cover when the water level sensor detects that the level of water within the water chamber of the casing is above a second threshold level, the second threshold level being higher than the first threshold level.

19. The refrigerator appliance of claim 11, wherein the water reservoir further comprises a baffle disposed within the water chamber of the casing, the baffle positioned and oriented for deflecting water flow through the water chamber of the casing towards an inner surface of the casing.

20. The refrigerator appliance of claim 11, wherein the water reservoir further comprises a relief conduit mounted to the casing above the air chamber of the cover, the relief conduit contiguous with ambient air about the casing.
